(19) United States
(12) Patent Application Publication
(10) Pub. No.: US 2026/0349455 A1
(43) Pub. Date: Nov. 5, 2026

(54) SENSING SYSTEMS INDICATIVE OF A MIXING RATIO FOR A MULTI-COMPONENT CURABLE POLYMERIC FLUID

(71) Applicant: GM Global Technology Operations LLC, Detroit, MI (US)

(72) Inventors: Selina Xinyue Zhao, Rochester Hills, MI (US); Dmitriy Bruder, Clinton Twp, MI (US); Mary Gilliam, Huntington Woods, MI (US); Robin James, Rochester Hills, MI (US); Michael J. Lukitsch, Marysville, MI (US); Megan E. McGovern, Detroit, MI (US); Jennifer Therese Bracey, Holly, MI (US); Xiaosong Huang, Novi, MI (US); Robert H. Dietze, Brighton, MI (US); Christopher Brady, Harrison Township, MI (US); Chloe Lawrie, Saint Clair Shores, MI (US)

(21) Appl. No.: 19/197,065

(22) Filed: May 2, 2025

(51) Int. Cl. G05D 11/13; B67D 3/00

(52) U.S. Cl. CPC G05D 11/135; B67D 3/0012; B67D 3/0058

(57) ABSTRACT

A multi-component polymeric fluid dispensing system for creating a curable polymeric fluid includes two or more material supply lines that each contain a corresponding individual polymeric fluid component, a mixing nozzle, at least one sensing system disposed along the mixing nozzle that measures one or more properties of the curable polymeric fluid that are indicative of a mixing ratio of the curable polymeric fluid, and one or more controllers in electronic communication with the at least one sensing system. The one or more controllers include one or more processors that execute instructions to receive the one or more properties from the at least one sensing system and determine the mixing ratio of the curable polymeric fluid based on the one or more properties.

The present disclosure relates to a multi-component polymeric fluid dispensing system including at least one sensing system that measures one or more properties indicative of the mixing ratio for a curable polymeric fluid.

A rechargeable energy storage system (RESS) employes battery modules or cells that store rechargeable electric energy that is used to propel a vehicle. It is to be appreciated that a rechargeable energy storage system may include various components that are constructed from two-part or multi-part polymeric materials such as, for example, structural adhesive materials (SAMs), thermal interfacial materials (TIMs), sealants, and potting materials.

Current systems for dispensing multi-component polymer fluids may include two or more material supply lines that each correspond to an individual polymeric component and a common mixing nozzle, which is also referred to as the static mixer, for combining the individual polymeric fluids together. The dispensing or mixing ratio refers to the proportional amounts of individual polymeric fluids that are combined together to create a curable polymeric fluid. Each component is composed of chemical compounds that react with other components, thereby initiating a chemical reaction that leads to curing into a hardened polymeric material. The curing process begins upon mixing of the components. The precise mixing ratio plays an important role in determining the chemical behavior, performance characteristics, and final properties of the cured polymeric material. For example, the mixing ratio affects the curing rate as well as the bonding strength of a two-part adhesive. During manufacturing, a technician is required to stop the assembly line, disassemble the mixing nozzle, and take mass measurements in order to verify the mixing ratio of the curable polymeric fluid. However, stopping the assembly line leads to system downtime. Furthermore, removal of the mixing nozzle results in a measurement that does not account for effects the mixing nozzle has on the final mix ratio of material exiting the mixing nozzle.

Thus, while multi-component polymeric fluid dispensing systems achieve their intended purpose, there is a need in the art for an improved approach for verifying the dispensing mixing ratio for a curable polymeric fluid that minimizes system downtime.

### SUMMARY

According to several aspects, a multi-component polymeric fluid dispensing system for creating a curable polymeric fluid is disclosed. The multi-component polymeric fluid dispensing system includes two or more material supply lines, where each of the two or more material supply lines contains a corresponding individual polymeric fluid component. The multi-component polymeric fluid dispensing system also includes a mixing nozzle including a feed end, a tip nozzle, and a discharge end. The feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end. The multi-component polymeric fluid dispensing system includes at least one sensing system that are disposed along the mixing nozzle that measures one or more properties of the curable polymeric fluid that are indicative of a mixing ratio of the curable polymeric fluid, and one or more controllers in electronic communication with the at least one sensing system. The one or more controllers include one or more processors that execute instructions to receive the one or more properties from the at least one sensing system and determine the mixing ratio of the curable polymeric fluid based on the one or more properties.

In another aspect, the at least one sensing system includes a light-based measurement device that determines one or more of the following: a colorimetry parameter, an absorbance of one or more wavelengths of light, a reflectance of one or more wavelengths of light, a transmittance of one or more wavelengths of light, and an emission of one or more wavelengths of light of the curable polymeric fluid.

In yet another aspect, the light-based measurement device is one of the following: a colorimeter, an infrared spectrophotometer, a Raman spectrophotometer, and a fluorescence spectrometer.

In an aspect, the at least one sensing system includes one or more dielectric sensors that are aligned with an opening disposed on an opposite side of a side wall of the mixing nozzle from the light-based measurement device.

In another aspect, the at least one sensing system is a single dielectric sensor disposed within a mixing zone of the mixing nozzle.

In yet another aspect, the multi-component polymeric fluid dispensing system further comprises a quality control sensor assembly positioned along at least one of the material supply lines.

In an aspect, the at least one sensing system includes a dual dielectric sensor assembly including two dielectric sensors that are each disposed within a mixing zone of the mixing nozzle.

In another aspect, the two dielectric sensors are each attached to opposite sides of a mixing element disposed within the mixing zone of the mixing nozzle.

In yet another aspect, the at least one sensing system includes a bi-coil sensor assembly having a housing, a first wire, a second wire, and an alternating current (AC) power supply.

In an aspect, the housing includes an inner surface that corresponds with an outer surface of the mixing nozzle, and wherein the first wire and the second wire are wound around the inner surface of the housing.

In another aspect, the AC power supply provides AC power to the first wire and the bi-coil sensor assembly operates as an eddy current sensor.

In yet another aspect, the AC power supply provides AC power to the first wire and the second wire, and the bi-coil sensor assembly operates as a parallel capacitive sensing array, and the first wire and the second wire are stripped bare and exposed wire is flush with the inner surface of the housing.

In an aspect, the at least one sensing system includes an acoustic transducer permanently attached to the mixing nozzle.

In another aspect, the at least one sensing system includes an open ended coaxial probe positioned directly adjacent to the discharge end of the mixing nozzle.

In yet another aspect, the open ended coaxial probe an open end that is flush with respect to an interior wall of a mixing zone of the mixing nozzle.

In an aspect, the one or more controllers includes one of the following: offline dispensing mixing ratio detection and inline dispensing mixing ratio detection.

In another aspect, the one or more controllers include the inline dispensing mixing ratio detection, and where the one or more controllers instruct at least one of the two or more material supply lines to modify one or more system target parameters of the corresponding individual polymeric fluid component in real-time based on a specified required range of the mixing ratio of the curable polymeric fluid.

In an aspect, a multi-component polymeric fluid dispensing system for creating a curable polymeric fluid is disclosed. The multi-component polymeric fluid dispensing system includes two or more material supply lines, where each of the two or more material supply lines contains a corresponding individual polymeric fluid component. The multi-component polymeric fluid dispensing system includes a mixing nozzle including a feed end, a tip nozzle, and a discharge end, where the feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end. The multi-component polymeric fluid dispensing system includes at least one sensing system disposed along the mixing nozzle that measures one or more properties of the curable polymeric fluid that are indicative of a mixing ratio of the curable polymeric fluid, and one or more controllers in electronic communication with the at least one sensing system. The one or more controllers includes one of the following: offline dispensing mixing ratio detection and inline dispensing mixing ratio detection. The one or more controllers include one or more processors that execute instructions to receive the one or more properties from the at least one sensing system and determine the mixing ratio of the curable polymeric fluid based on the one or more properties.

In another aspect, the one or more controllers includes the inline dispensing mixing ratio detection, and where the one or more controllers instruct at least one of the two or more material supply lines to modify one or more system target parameters of the corresponding individual polymeric fluid components in real-time based on a specified required range of the mixing ratio of the curable polymeric fluid.

In yet another aspect, a multi-component polymeric fluid dispensing system for creating a curable polymeric fluid is disclosed. The multi-component polymeric fluid dispensing system includes two or more material supply lines, wherein each of the two or more material supply lines contain a corresponding individual polymeric fluid component. The multi-component polymeric fluid dispensing system includes a mixing nozzle including a feed end, a tip nozzle, and a discharge end, where the feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end. The multi-component polymeric fluid dispensing system includes at least one sensing system disposed along the mixing nozzle that measures one or more properties of the curable polymeric fluid that are indicative of a mixing ratio of the curable polymeric fluid, and one or more controllers in electronic communication with the at least one sensing system. The one or more controllers includes inline dispensing mixing ratio detection. The one or more controllers include one or more processors that execute instructions to receive the one or more properties from the at least one sensing system, determine the mixing ratio of the curable polymeric fluid based on the one or more properties, and instruct at least one of the two or more material supply lines to modify one or more system target parameters of the corresponding individual polymeric fluid component in real-time based on a specified required range of the mixing ratio of the curable polymeric fluid.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed multi-component polymeric fluid dispensing system including two or more material supply lines, a mixing nozzle, and at least one sensing system in electronic communication with one or more controllers, according to an exemplary embodiment;

FIG. 2 is a cross-sectioned view of the mixing nozzle shown in FIG. 1, according to an exemplary embodiment;

FIG. 3 is an assembly view of a window assembly that is mounted to the mixing nozzle shown in FIG. 1, according to an exemplary embodiment;

FIGS. 4A-4B illustrates an alternative embodiment of the multi-component polymeric fluid dispensing system where the at least one sensing system is a single dielectric sensor, where FIG. 4A is a front view of the mixing nozzle and FIG. 4B is a cross-sectioned view of the mixing nozzle, according to an exemplary embodiment;

FIGS. 5A-5B illustrates another embodiment of the multi-component polymeric fluid dispensing system where the at least one sensing system is a double dielectric sensor, where FIG. 5A is a front view of the mixing nozzle and FIG. 5B is an assembly view of the mixing nozzle, according to an exemplary embodiment;

FIGS. 6A-6C illustrates yet another embodiment of the multi-component polymeric fluid dispensing system where the at least one sensing system is a bi-coil sensor assembly, where FIG. 6A is a front view of the mixing nozzle, FIG. 6B is a transparent view of the bi-col sensor assembly, and FIG. 6C is an enlarged cross-sectioned view of the bi-coil assembly, according to an exemplary embodiment;

FIG. 7 is an enlarged view of the discharge end of the mixing nozzle illustrating another embodiment of the multi-component polymeric fluid dispensing system where the at least one sensing system is an acoustic transducer, according to an exemplary embodiment; and

FIGS. 8A-8C illustrates yet another embodiment of the multi-component polymeric fluid dispensing system where the at least one sensing system is an open ended coaxial probe, where FIG. 8A is a front view of the mixing nozzle, FIG. 8B is front view of the coaxial probe, and FIG. 8C is a side view of the coaxial probe installed within the mixing nozzle, according to an exemplary embodiment.

### DETAILED DESCRIPTION

The following description is merely exemplary in nature and is not intended to limit the present disclosure, application, or uses.

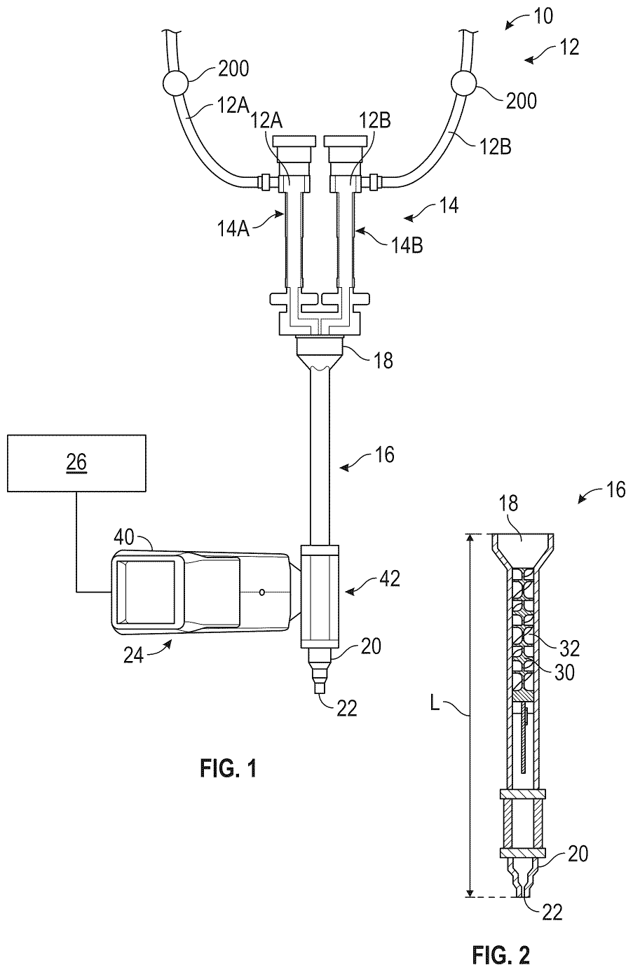

Referring to FIG. 1, a schematic diagram of the disclosed multi-component polymeric fluid dispensing system 10 for creating a curable polymeric fluid by mixing together two or more individual polymeric fluids is illustrated. Some examples of a curable polymeric fluid include, but are not limited to, structural adhesive materials (SAMs), thermal interfacial materials (TIMs), sealants, and potting materials. The multi-component polymeric fluid dispensing system 10 includes two or more material supply lines 12, where each material supply line 12 contains a corresponding individual polymeric fluid component. In the non-limiting embodiment as shown in FIG. 1, the multi-component polymeric fluid dispensing system 10 includes a first metering unit 14A that contains a first individual polymeric fluid component in a first supply line 12A and a second metering unit 14B that contains a second individual polymeric fluid component in a second supply line 12B, however, it is to be appreciated that the multi-component polymeric fluid dispensing system 10 may include more than two material supply lines 12 as well. Additionally, the multi-component polymeric fluid dispensing system 10 may also include other components such as, for example, components used for temperature control of incoming polymeric fluid components as well as components for measuring pressure and temperature.

Each metering unit 14 distributes a corresponding individual polymeric fluid at a target volumetric flowrate. The multi-component polymeric fluid dispensing system 10 includes a mixing nozzle 16, at least one sensing system 24, and one or more controllers 26. The one or more controllers 26 are in electronic communication with the at least one sensing system 24. The one or more controllers 26 are part of an integrated data acquisition system of the multi-component polymeric fluid dispensing system 10. The at least one sensing system 24 is positioned along the mixing nozzle 16 and measures one or more properties that are indicative of the mixing ratio of the curable polymeric fluid. The properties include chemical and physical measurements of the curable polymeric fluid.

The mixing nozzle includes a feed end 18, a tip nozzle 20, and a discharge end 22. FIG. 2 is a cross-sectioned view of the mixing nozzle 16 shown in FIG. 1. Referring to both FIGS. 1 and 2, the mixing nozzle 16 defines a mixing zone 30 that starts at the feed end 18, extends the entire length L of the mixing nozzle 16, and terminates at the discharge end 22. The feed end 18 of the mixing nozzle 16 receives the corresponding individual polymeric fluid components from each of the two or more material supply lines 12. The mixing nozzle 16 includes a mixing element 32 disposed within the mixing zone 30 that combines the corresponding individual polymeric fluid components together to create the curable polymeric fluid. The curable polymeric fluid exits the mixing zone 30 of the mixing nozzle 16 through the discharge end 22.

Continuing to refer to FIGS. 1 and 2, the one or more controllers 26 of the multi-component polymeric fluid dispensing system 10 receives the one or more properties from the at least one sensing system 24 and determines the mixing ratio of the curable polymeric fluid based on the correlation of the mixing ratio to the one or more properties.

If the multi-component polymeric fluid dispensing system 10 includes offline dispensing mixing ratio detection, then the one or more controllers 26 do not instruct the metering units 14 to modify the target volumetric flowrate of the material supply lines 12 during manufacturing in real-time. Instead, the output measurements are used to inform personnel at the plant of the mixing ratio of the curable polymeric fluid. For example, the multi-component polymeric fluid dispensing system 10 may also include an indicator such as a speaker or light-emitting device that creates an audible or visual alert to personal indicating the mixing ratio is no longer within a required range. Alternatively, if the multi-component polymeric fluid dispensing system 10 includes inline dispensing mixing ratio detection, then the one or more controllers 26 instruct at least one of the metering units 14 to modify one or more system target parameters such as, for example, the target volumetric flowrate of the corresponding individual polymeric fluid component in real-time based on a specified required range of the mixing ratio of the curable polymeric fluid. Specifically, the one or more controllers 26 may instruct an individual metering unit 14 to modify displacement to either increase or decrease the target volumetric flowrate in real-time depending upon the current value of the mixing ratio of the curable polymeric fluid. For example, if the current value of the mixing ratio indicates that the first individual polymeric fluid component in one or the material supply lines 12 should be increased, then the one or more controllers 26 may instruct the first metering unit 14A to increase the target volumetric flowrate in real-time. The at least one sensing system 24 may collect data indicative of one or more properties indicating the mixing ratio of the curable polymeric fluid regardless of whether the multi-component polymeric fluid dispensing system 10 is actively running or is temporarily stopped.

Referring to FIG. 1, in one non-limiting embodiment, the at least one sensing system 24 includes a light-based measurement device 40 disposed along the length L of the mixing nozzle 16 and the one or more properties include one or more colorimetry parameters, an absorbance one or more wavelengths of light, a reflectance one or more wavelengths of light, a transmittance one or more wavelengths of light, or emission of one or more wavelengths of light. The light-based measurement device 40 may be any type of instrument that determines one or more colorimetry parameters the absorbance one or more wavelengths of light, the reflectance one or more wavelengths of light, the transmittance one or more wavelengths of light, or the emission of one or more wavelengths of light of the curable polymeric fluid based on the amount of incident light absorbed, reflected, transmitted, or emitted by the curable polymeric fluid such as, for example, a colorimeter, an infrared spectrophotometer, a Raman spectrophotometer, or a fluorescence spectrometer.

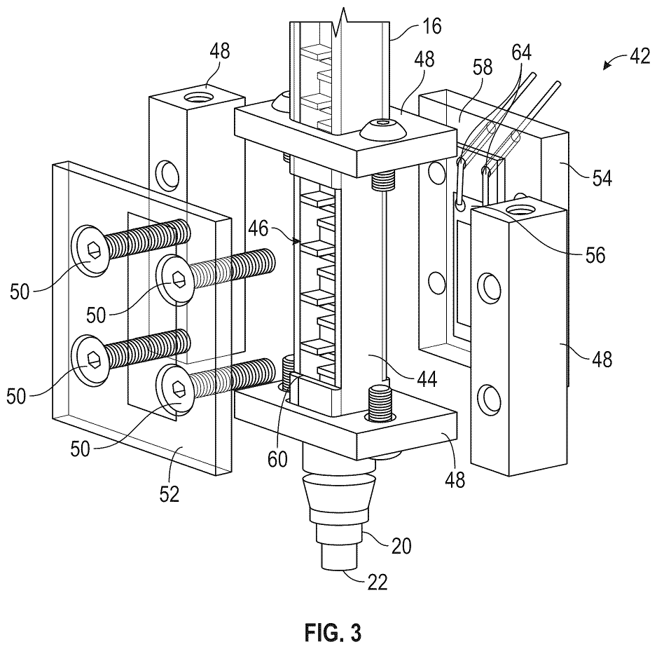

As seen in FIG. 1, a housing assembly 42 is disposed along the length L (FIG. 2) of the mixing nozzle 16 in a location directly adjacent to the discharge end 22. FIG. 3 is an enlarged assembly view of the housing assembly 42 shown in FIG. 1. Referring to FIGS. 1-3, a portion 46 of a side wall 44 defining the mixing zone 30 (FIG. 2) of the mixing nozzle 16 is removed to create an opening 60. A second opening (not visible in FIG. 3) is disposed along an opposite side of the side wall 44 where the opening 60 is located to accommodate one or more dielectric sensors 56, where the one or more dielectric sensors 56 are described below. The housing assembly 42 includes a plurality of mounting brackets 48, a plurality of fasteners 50, a transparent panel 52, a mounting panel 54, and the one or more dielectric sensors 56 that are disposed along an inner surface 58 of the mounting panel 54.

As seen in FIG. 3, the mounting brackets 48 position the transparent panel 52 over the opening 60 disposed along the side wall 44 of the mixing nozzle 16, and the plurality of fasteners 50 secure the transparent panel 52 to the mounting brackets 48. The transparent panel 52 acts as a window that allows for the incident light from the light-based measurement device 40 (FIG. 1) to enter the mixing nozzle 16 through the opening 60. Referring to FIGS. 1 and 3, the light-based measurement device 40 is positioned along the length L of the mixing nozzle 16 (FIG. 2) to direct incident light through the transparent panel 52 of the housing assembly 42 and into the mixing nozzle 16 where the curable polymeric fluid is located.

The light-based measurement device 40 generates one or more light-based parameters of the curable polymeric fluid based on the amount of incident light that is absorbed, reflected, transmitted, or emitted by the curable polymeric fluid. In one embodiment, the one or more light-based parameters include one or more of the following: tristimulus values, chromaticity coordinates, and the International Commission on Illumination (CIE) L*a*b* color values, where L* refers to lightness, a* represents red to green values, and b*represents blue to yellow values. It is to be appreciated that when colorimetry is used for measuring the curable polymeric fluid, the individual polymeric fluid components have colorimetry parameters that are distinct from each of the other components and the colorimetry parameters of the blended curable polymeric fluid are indicative of the mixing ratio of the curable polymeric fluid. In another embodiment, the one or more light-based measurements are extracted from a spectrum of the intensity or absorbance of the curable polymeric fluid at different wavelengths that correlate to the type and concentration of chemical bonds of the curable polymeric fluid. The extracted measurements from the spectrum may include one or more specific peak heights or areas or one or more ratios of two specific peak heights or areas. It is to be appreciated that the measurements extracted from the spectra are indicative of the mixing ratio of the curable polymeric fluid.

Continuing to refer to FIGS. 1 and 3, in the embodiment as shown the at least one sensing system 24 also includes the one or more dielectric sensors 56 that are aligned with the second opening (not visible in FIG. 3) disposed on the opposite side of the side wall 44 of the mixing nozzle 16 from the opening 60. The second opening allows for the one or more dielectric sensors 56 disposed along the inner surface 58 of the mounting panel 54 to measure properties such as the relative permittivity, the capacitance, and the resistivity or ion viscosity of the curable polymeric fluid located within the mixing nozzle 16. In the non-limiting embodiment as shown in FIG. 3, a single dielectric sensor 56 including two non-contact electrodes 64 is disposed along the inner surface 58 of the mounting panel 54. Although FIGS. 1 and 3 illustrate both the light-based measurement device 40 and the one or more dielectric sensors 56, it is to be appreciated that the multi-component polymeric fluid dispensing system 10 may only include the light-based measurement device 40 or the one or more dielectric sensors 56.

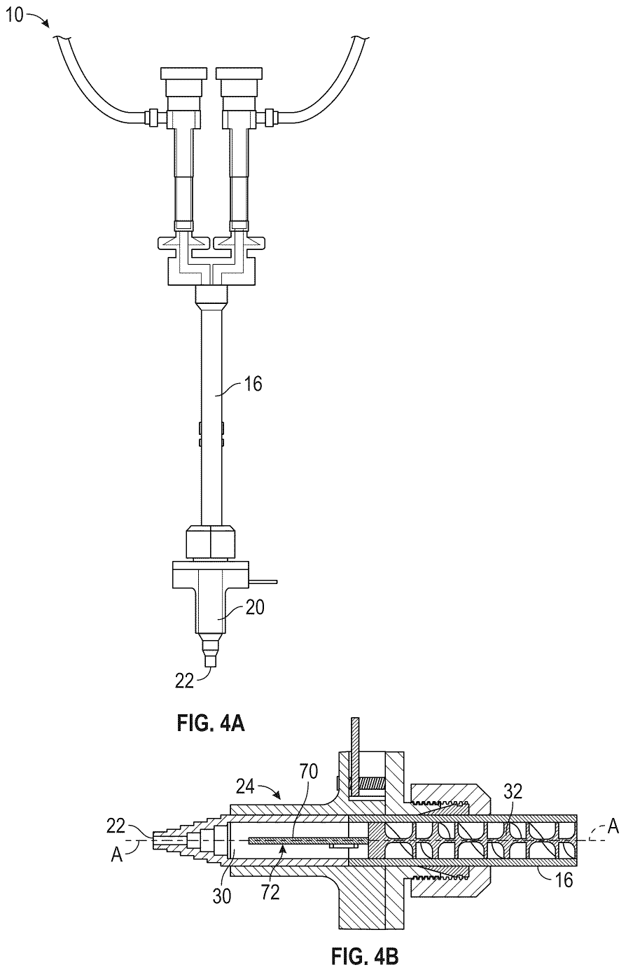

FIGS. 4A-4B illustrate an alternative embodiment of the multi-component polymeric fluid dispensing system 10 where the at least one sensing system 24 is a single dielectric sensor 70 disposed within the mixing zone 30 of the mixing nozzle 16, where FIG. 4A is a front view of the mixing nozzle 16 and FIG. 4B is a cross-sectioned view of the mixing nozzle 16. Specifically, the single dielectric sensor 70 is disposed downstream of the mixing element 32 disposed within the mixing zone 30 of the mixing nozzle 16, within the tip nozzle 20 of the mixing nozzle 16. In the embodiment as shown in FIG. 4B, the single dielectric sensor 70 includes a planar profile 72, and is aligned with a center axis A-A of the mixing nozzle 16. It is to be appreciated that the single dielectric sensor 70 is positioned within the mixing zone 30 of the mixing nozzle 16 to align with the flow of the curable polymeric fluid exiting the discharge end 22. The single dielectric sensor 70 is also positioned within the mixing zone 30 of the mixing nozzle 16 so as to be located within the middle of the advancing edge of the curable polymeric fluid exiting the discharge end 22.

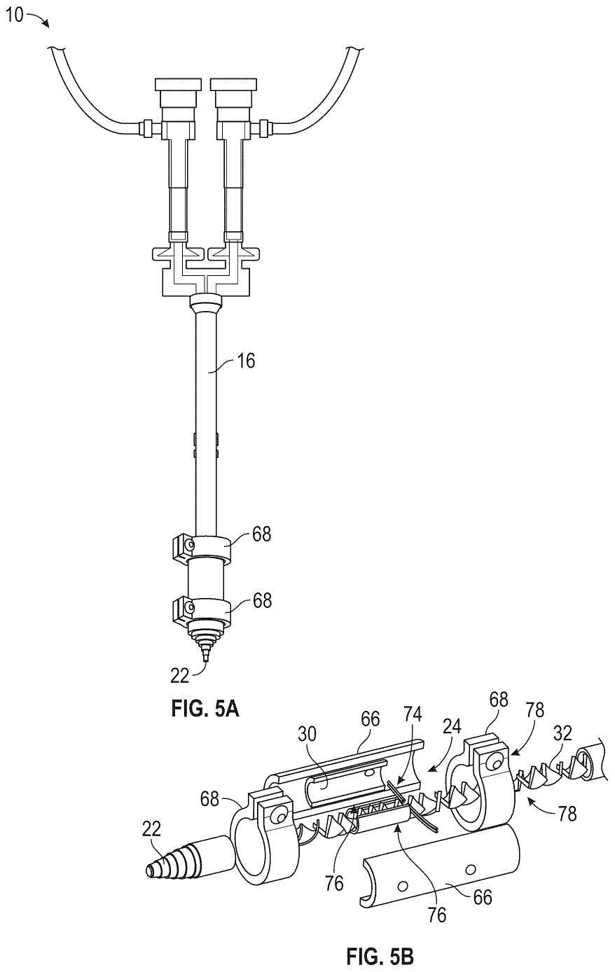

FIGS. 5A-5B illustrates yet another embodiment of the multi-component polymeric fluid dispensing system 10 where the at least one sensing system 24 includes a dual dielectric sensor assembly 74 including two dielectric sensors 76 that are each disposed within the mixing zone 30 of the mixing nozzle 16, where FIG. 5A is a front view of the mixing nozzle 16 and FIG. 5B is an assembly view of the mixing nozzle 16. In the non-limiting embodiment as shown in FIGS. 5A-5B, the mixing nozzle 16 is formed by two cylindrical half-shells 66 that are secured together by two clamps 68. As seen in FIG. 5B, the two dielectric sensors 76 are attached to opposite sides 78 of the mixing element 32 disposed within the mixing zone 30 of the mixing nozzle 16. The two dielectric sensors 76 are positioned within the mixing zone 30 of the mixing nozzle 16 to align with the flow of the curable polymeric fluid exiting the discharge end 22. The half-shells 66 and the two dielectric sensors 76 are positioned along the mixing nozzle 16 to capture adequate mixing between the two or more individual polymeric fluid components, to accommodate pressure limits of the half-shells 66 that are secured by the clamps 68, and to ensure that the discharge end 22 has enough material to be adequately secured by the clamps 68 without issues.

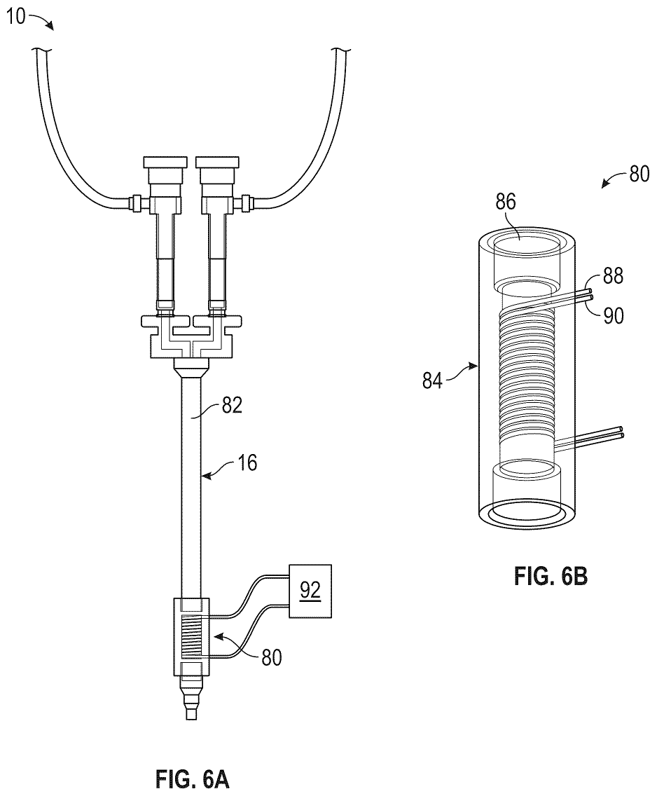

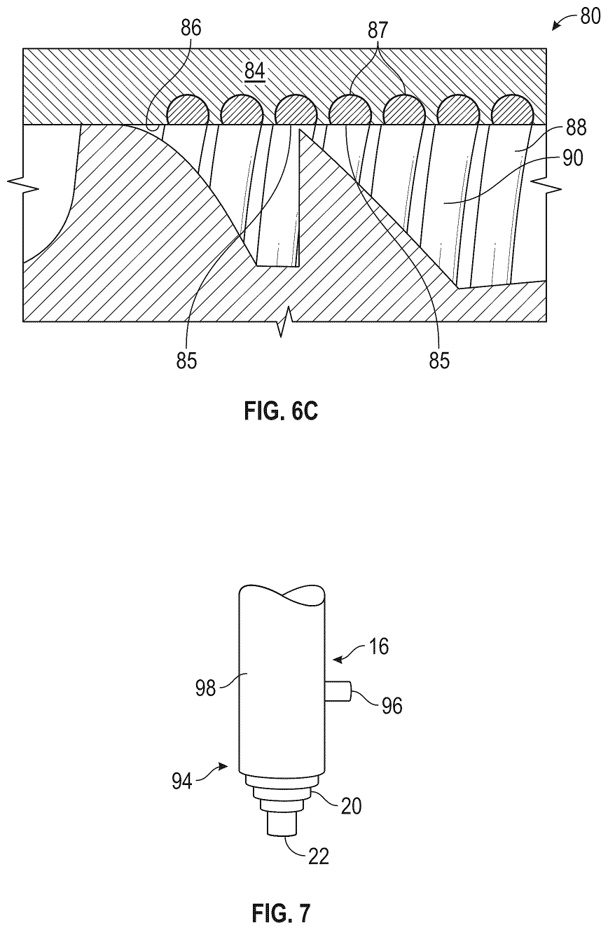

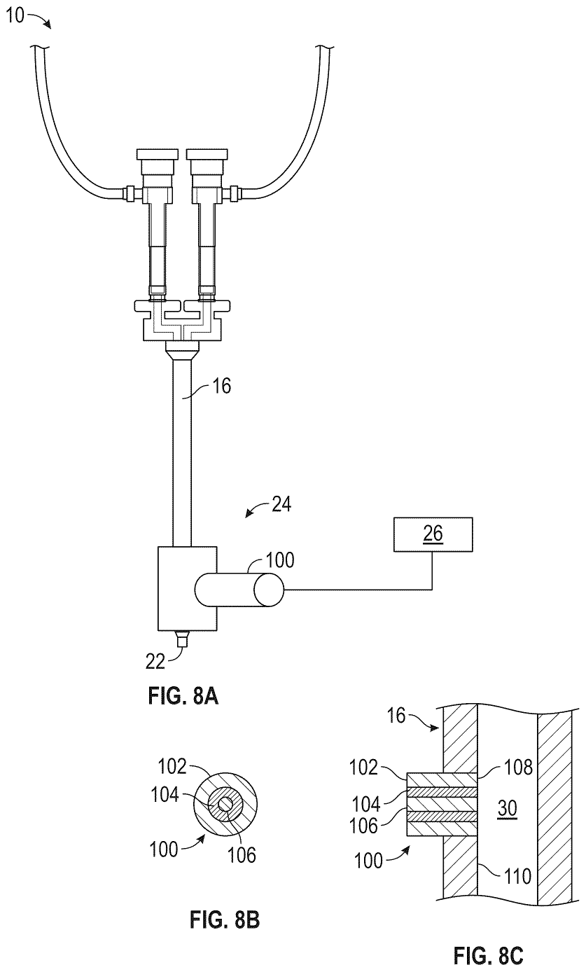

FIGS. 6A-6C illustrates yet another embodiment of the multi-component polymeric fluid dispensing system 10 where the at least one sensing system 24 includes a bi-coil sensor assembly 80 that is disposed around an outer surface 82 of the mixing nozzle 16. FIG. 6A is a front view of the mixing nozzle 16, FIG. 6B is a transparent view of the bi-coil sensor assembly 80, and FIG. 8C is an enlarged view of a portion of the bi-coil sensor assembly 80 and a portion of the mixing element 32. The bi-coil sensor assembly 80 includes a housing 84 that includes an inner surface 86 that corresponds with the outer surface 82 of the mixing nozzle 16. In the exemplary embodiment as shown in FIG. 6A, the mixing nozzle 16 includes a cylindrical outer surface 82 and the housing 84 includes a cylindrical inner surface 86, however, it is to be appreciated that the mixing nozzle 16 and the housing 84 of the bi-coil sensor assembly 80 are not limited to cylindrical profiles. The bi-coil sensor assembly 80 includes a double coil configuration where a first wire 88 and a second wire 90 are both wound around the inner surface 86 of the housing 84.

An alternating current (AC) power supply 92 provides AC power to either the first wire 88 or both the first wire 88 and the second wire 90. When the AC power supply 92 provides power to the first wire 88, the bi-coil sensor assembly 80 operates as an eddy current sensor that measures properties such as the resistance, inductance, and capacitance of the curable polymeric fluid located within the mixing zone 30 of the mixing nozzle 16 (FIG. 2). In an alternative embodiment, the AC power supply 92 provides AC power to both the first wire 88 and the second wire 90 and the bi-coil sensor assembly 80 operates as a parallel capacitive sensing array that measures properties such as the relative permittivity, the capacitance, and the resistivity or ion viscosity of the curable polymeric fluid located within the mixing nozzle 16. Referring to FIG. 6C, in the embodiment where AC power is provided to both the first wire 88 and the second wire 90 and the bi-coil sensor assembly 80 operates as a parallel capacitive sensing array, the wires 88, 90 are wound around the inner surface 86 and are encased within the housing 84. The inner surface 86 of the housing 84 is then machined to strip the wires 88, 90 and remove a portion of the surrounding insulation 87 so that exposed portions 85 of the wires 88, 90 are co-planar with the inner surface 86 of the housing 84. In other words, the first wire 88 and the second wire 90 are stripped bare and exposed wire is flush with the inner surface 86 of the housing 84.

FIG. 7 is an enlarged view the tip nozzle 20 of the mixing nozzle 16, where the at least one sensing system 24 is an acoustic transducer assembly 94. The acoustic transducer assembly 94 measures the longitudinal reflection coefficient of the curable polymeric fluid located within the mixing nozzle 16. The longitudinal reflection coefficient is indicative of the acoustic velocity and density of the curable polymeric fluid, where the acoustic velocity and the density correlate to the mixing ratio. In the embodiment as shown in FIG. 7, the acoustic transducer assembly 94 includes an acoustic transducer 96 and a waveguide 98, where the waveguide 98 is shaped as a cylindrical sleeve that is affixed anywhere along the length L of the mixing nozzle 16. The acoustic transducer 96 is permanently attached to the mixing nozzle 16 and is positioned so as not to impede the flow of the curable polymeric fluid exiting the discharge end 22.

FIGS. 8A-8C illustrate yet another embodiment where the at least one sensing system 24 includes an open ended coaxial probe 100 positioned directly adjacent to the discharge end 22 of the mixing nozzle 16. The open ended coaxial probe 100 operates at microwave frequencies ranging from about 300 megahertz (MHz) to about 300 gigahertz (GHz) to measure properties that include the complex permittivity of curable polymeric fluid. As seen in FIG. 8B, the open ended coaxial probe 100 includes an outer conductor 102, an insulator 104, an inner conductor 106, and an open end 108. Referring to FIG. 8C, the open end 108 of the open ended coaxial probe 100 is flush with respect to an interior wall 110 of the mixing zone 30 of the mixing nozzle 16.

Referring to FIG. 1, in one non-limiting embodiment a quality control sensor assembly 200 may be positioned along at least one of the material supply lines 12. The quality control sensor assembly 200 measures one or more material properties of the corresponding individual polymeric fluid component located in the supply line 12. It is to be appreciated that the quality control sensor assembly 200 may include any of the sensing systems illustrated in FIGS. 1-8C. Merely by way of example, in one embodiment, the quality control sensor assembly 200 may include the light-based measurement device 40. The quality control sensor assembly 200 is also in electronic communication with the one or more controllers 26.

Referring generally to the figures, the disclosed multi-component polymeric fluid dispensing system provides various technical effects and benefits. Specifically, each of the disclosed sensing systems provide a flexible approach for measuring one or more properties that are indicative of the mixing ratio for the curable polymeric fluid without the need for a process technician or other individual to stop the assembly line to take measurements. Accordingly, the disclosed multi-component polymeric fluid dispensing system reduces or eliminates system downtime during the manufacturing process.

As mentioned above, in embodiments the controllers are part of an integrated data acquisition system of the multi-component polymeric fluid dispensing system. The one or more controllers of the integrated data acquisition system may execute computer program code, such as software applications that are responsible for acquiring, analyzing, and responding to sensor data. In embodiments, the integrated data acquisition may create an alert informing end users that the mixing ratio is no longer within a required range. The integrated data acquisition system collects sensor data in real time or batch mode, analyzes the data locally or remotely, and generates control signals when the system is actively operating (i.e., the inline dispensing mixing ratio detection) or alerts when the system is paused or inactive (i.e., the offline dispensing mixing ratio detection).

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A multi-component polymeric fluid dispensing system for creating a curable polymeric fluid, the multi-component polymeric fluid dispensing system comprising:
two or more material supply lines, wherein each of the two or more material supply lines contain a corresponding individual polymeric fluid component;
a mixing nozzle including a feed end, a tip nozzle, and a discharge end, wherein the feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end;
at least one sensing system disposed along the mixing nozzle that measures one or more properties of the curable polymeric fluid that are indicative of a mixing ratio of the curable polymeric fluid; and
one or more controllers in electronic communication with the at least one sensing system, wherein the one or more controllers include one or more processors that execute instructions to:
receive the one or more properties from the at least one sensing system; and
determine the mixing ratio of the curable polymeric fluid based on the one or more properties.

2. The multi-component polymeric fluid dispensing system of claim 1, wherein the at least one sensing system includes a light-based measurement device that determines one or more of the following: a colorimetry parameter, an absorbance of one or more wavelengths of light, a reflectance of one or more wavelengths of light, a transmittance of one or more wavelengths of light, and an emission of one or more wavelengths of light of the curable polymeric fluid.

3. The multi-component polymeric fluid dispensing system of claim 2, wherein the light-based measurement device is one of the following: a colorimeter, an infrared spectrophotometer, a Raman spectrophotometer, and a fluorescence spectrometer.

4. The multi-component polymeric fluid dispensing system of claim 2, wherein the at least one sensing system includes one or more dielectric sensors that are aligned with an opening disposed on an opposite side of a side wall of the mixing nozzle from the light-based measurement device.

5. The multi-component polymeric fluid dispensing system of claim 1, wherein the at least one sensing system is a single dielectric sensor disposed within a mixing zone of the mixing nozzle.

6. The multi-component polymeric fluid dispensing system of claim 1, further comprising a quality control sensor assembly positioned along at least one of the material supply lines.

7. The multi-component polymeric fluid dispensing system of claim 1, wherein the at least one sensing system includes a dual dielectric sensor assembly including two dielectric sensors that are each disposed within a mixing zone of the mixing nozzle.

8. The multi-component polymeric fluid dispensing system of claim 7, wherein the two dielectric sensors are each attached to opposite sides of a mixing element disposed within the mixing zone of the mixing nozzle.

9. The multi-component polymeric fluid dispensing system of claim 1, wherein the at least one sensing system includes a bi-coil sensor assembly having a housing, a first wire, a second wire, and an alternating current (AC) power supply.

10. The multi-component polymeric fluid dispensing system of claim 9, wherein the housing includes an inner surface that corresponds with an outer surface of the mixing nozzle, and wherein the first wire and the second wire are wound around the inner surface of the housing.

11. The multi-component polymeric fluid dispensing system of claim 10, wherein the AC power supply provides AC power to the first wire and the bi-coil sensor assembly operates as an eddy current sensor.

12. The multi-component polymeric fluid dispensing system of claim 10, wherein the AC power supply provides AC power to the first wire and the second wire and the bi-coil sensor assembly operates as a parallel capacitive sensing array, and wherein the first wire and the second wire are stripped bare and exposed wire is flush with the inner surface of the housing.

13. The multi-component polymeric fluid dispensing system of claim 1, wherein the at least one sensing system includes an acoustic transducer permanently attached to the mixing nozzle.

14. The multi-component polymeric fluid dispensing system of claim 1, wherein the at least one sensing system includes an open ended coaxial probe positioned directly adjacent to the discharge end of the mixing nozzle.

15. The multi-component polymeric fluid dispensing system of claim 14, wherein the open ended coaxial probe an open end that is flush with respect to an interior wall of a mixing zone of the mixing nozzle.

16. The multi-component polymeric fluid dispensing system of claim 1, wherein the one or more controllers includes one of the following: offline dispensing mixing ratio detection and inline dispensing mixing ratio detection.

17. The multi-component polymeric fluid dispensing system of claim 16, wherein the one or more controllers includes the inline dispensing mixing ratio detection, and wherein the one or more controllers instruct at least one of the two or more material supply lines to modify one or more system target parameters of the corresponding individual polymeric fluid component in real-time based on a specified required range of the mixing ratio of the curable polymeric fluid.

18. A multi-component polymeric fluid dispensing system for creating a curable polymeric fluid, the multi-component polymeric fluid dispensing system comprising:
two or more material supply lines, wherein each of the two or more material supply lines contain a corresponding individual polymeric fluid component;
a mixing nozzle including a feed end, a tip nozzle, and a discharge end, wherein the feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end;
at least one sensing system disposed along the mixing nozzle that measures one or more properties of the curable polymeric fluid that are indicative of a mixing ratio of the curable polymeric fluid; and
one or more controllers in electronic communication with the at least one sensing system, wherein the one or more controllers includes one of the following: offline dispensing mixing ratio detection and inline dispensing mixing ratio detection, and wherein the one or more controllers include one or more processors that execute instructions to:
receive the one or more properties from the at least one sensing system; and
determine the mixing ratio of the curable polymeric fluid based on the one or more properties.

19. The multi-component polymeric fluid dispensing system of claim 18, wherein the one or more controllers includes the inline dispensing mixing ratio detection, and wherein the one or more controllers instruct at least one of the two or more material supply lines to modify one or more system target parameters of the corresponding individual polymeric fluid components in real-time based on a specified required range of the mixing ratio of the curable polymeric fluid.

20. A multi-component polymeric fluid dispensing system for creating a curable polymeric fluid, the multi-component polymeric fluid dispensing system comprising:
two or more material supply lines, wherein each of the two or more material supply lines contain a corresponding individual polymeric fluid component;
a mixing nozzle including a feed end, a tip nozzle, and a discharge end, wherein the feed end of the mixing nozzle receives the corresponding individual polymeric fluid components from each of the two or more material supply lines, the mixing nozzle combines the corresponding individual polymeric fluid components together to create the curable polymeric fluid, and the curable polymeric fluid exits the mixing nozzle through the discharge end;
at least one sensing system disposed along the mixing nozzle that measures one or more properties of the curable polymeric fluid that are indicative of a mixing ratio of the curable polymeric fluid; and
one or more controllers in electronic communication with the at least one sensing system, wherein the one or more controllers includes inline dispensing mixing ratio detection, and wherein the one or more controllers include one or more processors that execute instructions to:
receive the one or more properties from the at least one sensing system;
determine the mixing ratio of the curable polymeric fluid based on the one or more properties; and
instruct at least one of the two or more material supply lines to modify one or more system target parameters of the corresponding individual polymeric fluid component in real-time based on a specified required range of the mixing ratio of the curable polymeric fluid.
